(19) United States
(12) Patent Application Publication
(10) Pub. No.: US 2007/0031131 A1
(43) Pub. Date: Feb. 8, 2007

(54) SYSTEM FOR MEASURING THE POSITION OF AN ELECTRIC MOTOR

(75) Inventor: Jonathan C. Griffitts, Boulder, CO (US)

Correspondence Address: MOUNTAIN ENGINEERING II, INC., 1233 SHERMAN DR., LONGMONT, CO, 80501, US

(73) Assignee: MOUNTAIN ENGINEERING II, INC., Longmont, CO (US)

(21) Appl. No.: 11/161,461

(22) Filed: Aug. 4, 2005

(51) Int. Cl. H02P 7/29

(52) U.S. Cl. 388/811

(57) ABSTRACT

An electronic system utilizing dynamic inductance changes in the windings of an electric motor to measure and monitor mechanical position. The method employs the AC component of the Pulse-Width Modulation (PWM) which is commonly used to drive motor windings without the need for injected AC signals or external position sensors. When a winding of the motor is driven with such an AC signal, the winding inductances form a voltage divider across the center node of a Y-connected motor. Inductance changes in the windings occur as the poles of the rotor pass by the poles of the stator. Considering the PWM drive as an AC stimulus, the voltage response at the center node varies with these inductance changes in the legs on either side; this amplitude variation corresponds to a measurement of rotational position. These measurements provide position/velocity feedback to a servo controller as long as current runs through a motor winding. This position sensing also applies to sensorless control of commutation in brushless DC and switched-reluctance motors.

### FIELD OF THE INVENTION

This invention relates to control of polyphase electric motors, specifically to measurement of the rotor position without need for external position sensors.

### REFERENCES CITED

U.S. Pat. No. 3,931,553 (January 1976) to Stich, et al.

U.S. Pat. No. 4,027,212 (May 1977) to Studer

U.S. Pat. No. 4,092,572 (May 1978) to Murata

U.S. Pat. No. 4,495,450 (January 1985) to Tokizaki, et al

U.S. Pat. No. 4,654,566 (March 1987) to Erdman

U.S. Pat. No. 4,758,768 (July 1988) to Hendricks, et al

U.S. Pat. No. 4,882,524 (November 1989) to Lee

U.S. Pat. No. 5,191,270 (March 1993) to McCormack

U.S. Pat. No. 5,192,900 (March 1993) to Ueki

U.S. Pat. No. 5,304,902 (April 1994) to Ueki

U.S. Pat. No. 5,327,053 (July 1994) to Mann, et al

U.S. Pat. No. 5,350,987 (September 1994) to Ueki

U.S. Pat. No. 5,725,125 (May 1998) to Weiss

U.S. Pat. No. 5,821,713 (October 1998) to Holling, et al.

U.S. Pat. No. 5,864,217 (January 1999) to Lyons, et al

U.S. Pat. No. 5,990,642 (November 1999) to Park

U.S. Pat. No. 6,169,354 (February 2001) to Springer, et al.

U.S. Pat. No. 6,304,045 (October 2001) to Muszynski

U.S. Pat. No. 6,703,805 (March 2004) to Griffitts

U.S. Pat. No. 6,839,653 (January 2005) to Gerlach

U.S. Pat. No. 6,859,000 (February 2005) to Kessler, et al.

U.S. Pat. No. 6,879,124 (April 2005) to Jiang, et al.

U.S. Pat. No. 6,885,970 (April 2005) to Petrovic, et al.

U.S. Pat. No. 6,888,331 (May 2005) to Morales Serrano

### OTHER PUBLICATIONS

Conference Record of the IEEE Industry Applications Meeting (1999, p. 143), “Review of Sensorless Methods for Brushless DC”

Conference Record of the IEEE Industry Applications Meeting (1999, p 151), “Sensorless Brushless DC Control Using A Current Waveform Anomaly”

IEEE Transactions on Power Electronics, Vol. 19, No. 6 (2004, p 1568), “Inductance Model-Based Sensorless Control of the Switched Reluctance Motor Drive at Low Speed”

IEEE Transactions on Power Electronics, Vol. 19, No. 6 (2004, p 1601), “A Novel Approach for Sensorless Control of PM Machines Down to Zero Speed Without Signal Injection or Special PWM Technique”

IEEE Transactions on Power Electronics, Vol. 19, No. 6 (2004, p 1635), “Sensorless Control of the BLDC Motors From Near-Zero to High Speeds”

NASA Technical Memorandum NASA/TM—2004-213356 (2004), “Control of a High Speed Flywheel System for Energy Storage in Space Applications”

### BACKGROUND OF THE INVENTION

Many types of electrical motors are known. All electrical motors have a stator and a moving component. In rotary motors the moving component is called a “rotor”. In linear motors the moving component is typically called a “slider” This invention applies to all polyphase synchronous motors, including “brushless DC”, switched reluctance motors, and linear motors. For simplicity, the term “rotor” is used here to refer to the moving component of all motors, and it is understood that the term “rotor” also comprises “sliders”.

FIG. 1 illustrates one type of electric motor. At the center of the motor is the rotor 1 which is the moving part of the motor. The rotor contains eight permanent magnets 2 arranged as shown so that a sequence of alternating North and South magnetic poles are exposed along the outer rim. In this drawing the rotor is shown to be rotating in a counterclockwise direction.

Surrounding the rotor is the stator 3, which is stationary. The stator is made up of twelve electromagnets 4, divided up into three phases A, B, and C. All four electromagnets of phase A are driven together by the same electrical signal, and likewise for phases B and C. The apparatus to drive the three phases of electrical current is outside the motor and not shown in FIG. 1. This example motor would be termed a three-phase, eight-pole, brushless DC motor.

The principle of operation of such a motor uses the currents in the stator electromagnets to generate a rotating magnetic field. As the rotor rotates, the currents in the stator phases are dynamically changed to keep the generated magnetic field aligned with the magnetic poles on the rotor in such a way as to induce the desired torque on the rotor.

A common and simple method for rotating the magnetic field is called commutation, in which the properly-aligned stator windings are switched on dynamically, depending on the rotor alignment. FIG. 1a illustrates the commutation state at a particular moment in time. Phase A is switched off (no current flow), phase B is energized to generate a North pole at the inside of the stator, and phase C generates a South pole at the inside of the stator. The rotor pole 5 is between the two active stator poles and will be forced to the right due to magnetic attraction to the South pole on phase C and repulsion from the North pole on phase B. Rotor pole 6 will also be forced to the right due to magnetic forces.

As the rotation of the rotor moves its poles, the geometry changes cause changes in the magnetic forces. The commutation process must switch the winding currents appropriately to maintain the proper magnetic alignment. To illustrate this, FIG. 1b shows the commutation state after the motor has rotated 15 degrees clockwise. Phase C is now switched off, phase A is generating a South pole and phase B continues to generate a North pole. This shifts the stator's magnetic field to the right to correspond with the new rotor position, and the magnetic forces continue to force the rotor poles to the right.

This description of commutation illustrates that it is critically important to the operation of all electric motors to keep the rotating electric fields in alignment with the rotational position of the rotor. Other methods exist for generating the rotating magnetic field, some of which involve much more complex voltage waveforms such as sinusoidal waves. In all cases, the waveform or switching pattern must advance as the rotor turns in a manner which synchronizes the rotating magnetic field with the rotor position.

The example motor in FIG. 1 represents one common configuration for a rotary motor. Many other configurations are in common use. For example, the rotor magnets may be made up of electromagnets instead of permanent magnets; in this case the stator may or may not use permanent magnets. The rotor may not be magnetic at all but use simple steel or iron shapes that are attracted to the stator magnets (switched-reluctance motors). Other possible configurations include having the stationary stator inside the rotor or alongside it in the axial direction. The disclosed invention can be applied in all these configurations.

FIG. 2 illustrates an example of one configuration of a linear motor. It has a three-phase stator 8 made up of windings, which surround both sides of the slider 7 which moves vertically as shown by the arrows. Operation of this linear motor is very similar to that of the rotary motor just described. The three stator phases A, B, and C correspond to the phases in the rotary motor's stator, and the permanent magnet poles in the slider correspond to the rotor magnets. The number of stator windings and rotor poles is arbitrary, and depends on the needed physical length of travel.

As with the rotary motor, linear motors can have many other configurations, and the disclosed invention is applicable to all.

The commutation illustrated in FIGS. 1a and 1b describes one common method of generating a rotating magnetic field, with the three phases switched sequentially through three states (off, North, or South). There are many different schemes for driving electric motors, many of which involve driving the different phases with more complex waveforms rather than simple switching. All methods must share the common concept of controlling the electromagnet drive currents to generate a rotating magnetic field that is synchronized to the rotor position. Accordingly, the mechanical position of the rotor relative to the stator must be known by the driving apparatus in order to provide proper control of the windings. Many types of position sensing apparatus have been used with electric motors.

The simplest form of position sensing in DC motors is the mechanical commutator. This consists of brushes in contact with a commutator that rotates with the rotor. The brush commutator is still extensively used but suffers from the disadvantages of friction and wear between the brushes and the commutator surfaces, and consequential reliability and maintenance problems are the result. A commutator also adds complexity and size to the motor.

Brushless DC motors avoid these problems by commutating electronically. Electronic commutation has traditionally required the use of external position sensors mounted on the motor. The most common of these sensors are Hall-effect magnetic sensors mounted near the rotor. This technique is described in many places (i.e. ref. U.S. Pat. Nos. 4,092,572 and 4,758,768). If greater angular resolution and accuracy is needed, an optical shaft encoder is sometimes used in addition to, or instead of, Hall-effect sensors. Use of an optical encoder for commutation is described in ref. U.S. Pat. No. 4,882,524. Another standard sensor technology is a magnetic resolver. Other types of external sensors have also been used or suggested. ref. U.S. Pat. No. 3,931,553 describes the use of a capacitative rotation sensor for commutation control; ref. U.S. Pat. No. 5,864,217 describes use of a toothed wheel and magnetic pickup sensor; and ref. U.S. Pat. No. 4,027,212 describes techniques for motor commutation controlled by external rotation sensors in general.

All of the above methods add extra cost to the system and take up extra space in or near the motor. In addition, some of the aforementioned methods have accuracy and reliability issues. To avoid these liabilities, many ideas have been previously pursued in order to find ways of eliminating extra position sensing components.

Many papers and articles have been published exploring different methods for sensorless motor control. A useful summary was presented at the 1999 IEEE Industry Applications Meeting (1999), titled “Review of Sensorless Methods for Brushless DC”.

The most common approach for sensorless control of rotary motors is to sense the motor rotation by monitoring of the induced voltage in the motor windings caused by the rotating magnetic field of the rotor. This voltage waveform (termed back-EMF) is commonly monitored in a motor winding that is turned off; the winding used for voltage waveform monitoring shifts as the motor commutation rotates between the windings.

A major disadvantage is that this method works only when the rotor is rotating at a reasonable speed, since there is no induced voltage from a stationary magnetic field. Some special technique must thus be used to get rotation started. This is acceptable in some applications such as fans and disk drives that use a constant motor rotational speed when operating, but it is unacceptable for many other applications such as robotics and tape drive applications where the motor must remain under close control when being held in a stationary position. Back-EMF sensing is commonly employed in many existing commercial products where these drawbacks are acceptable. Variations on this concept are well known in the present art. They are described in many places including the reference U.S. Pat. Nos. 6,304,045, 4,495,450, 4,654,566, and 6,879,124, and also in many published articles.

Several methods of rotor position-sensing have also been suggested that involve adding position-sensing windings to a motor (ref. U.S. Pat. No. 6,169,354). However these methods also add undesirable cost and complexity to the motor.

Some research and experimentation has been done with other sensorless motor drive techniques that use measurement of impedance variations in the windings to derive the motor mechanical position. These impedance changes take place as the magnetic poles of the rotor pass by the poles of the stator. The inductance component of the impedance shows by far the most significant changes, so it is normally desirable to measure winding inductance. FIG. 5 is a graph showing actual measured inductance variations vs. rotor position, in a brushless DC motor. Inductance cannot be measured with a DC or low-frequency stimulus, so some higher-frequency signal must be part of the measurement process. Generally the inductance-measurement methods involve inducing an AC test signal into the motor in addition to the actual motor drive currents, and measuring the high-frequency response. These signals may be pulses or may be continuous AC signals, as discussed in ref. U.S. Pat. No. 5,990,642.

U.S. Pat. No. 6,703,805 discloses use of a bridge amplifier to measure the impedance ratio between windings of a motor, and using that ratio to derive position information. If this technique is to measure the inductance component of the impedances, it also requires an AC signal component to be present in the motor drive voltages.

Several other proposed sensorless methods use dynamic measurements of winding current and applied voltage to derive mechanical position of the motor. The motor commutation is driven based on an estimated/extrapolated motor position, and the measured voltage and current parameters are used to correct the estimate through one of a variety of mathematical techniques including fundamental machine equations, dynamic models, and “observers”. An “observer” in this context could also be called a “state observer”, and refers to specific mathematical technique(s) that consist of a mechanism (usually implemented in software) that monitors parameters of the system in operation (i.e. motor and motor-controller) and derives information that can't be directly measured. U.S. Pat. No. 6,885,970 discloses one example and similar methods are often studied in academic papers. These techniques tend to require a great deal of complex computation to be done in real-time as the motor runs, tend to have a slow sampling frequency, and may not work when the motor is in a steady-state and not rotating.

When contemplating the need for an AC stimulus to measure inductance, some workers have observed that motor windings usually have an AC component from the commonly-used pulse-width modulation (PWM) drive. Pulse-width modulation is a way to improve efficiency and reduce heat in the motor-current drivers. A motor winding will often need to be driven with less than the full power-supply voltage. Driving a winding with only part of the available voltage results in high losses in the driver circuitry. For example, FIG. 3a shows a motor winding 10 being driven with a 1 Ampere current at a terminal voltage of 6 Volts, but the available power-supply is 12 Volts. The driver 9 is passing 1 Ampere but has a drop of 6 Volts across it, so it is dissipating 6 Watts as internal heat. The winding 10 also dissipates 6 Watts so half of the total power is being wasted in heating up the driver 9. FIG. 3b shows the same motor-drive implemented with pulse-width modulation, in which the driver is replaced with a switch 11 capable of setting the terminal voltage to the full 12 Volt power supply half the time and to 0 volts the other half of the time on a fast AC cycle. The average terminal voltage is still 6 Volts, and the average motor current will be the same as for a 6 Volt drive, but the switch 11 dissipates no internal power except for small parasitic losses. This gives much greater efficiency than a simple analog driver. Inductance in the motor winding causes the current to react slowly to the voltage changes, so the current response 12 shows a small triangular ripple at the PWM frequency. To control the effective drive voltage the pulse-width of the switch is changed as shown by the dotted-lines in the graphs; when the switch spends a greater proportion of time at 12 Volts the effective drive voltage is increased. A PWM switch is typically implemented using semiconductors and cycles at a frequency of many KHz. For clarity FIG. 3b represents a very simplified version of a PWM switch, but this basic concept is commonly used in many variations of different levels of complexity.

The amplitude of the ripple in the current response 12 in FIG. 3b is proportional to the inductance of the motor winding 10 so this amplitude can be measured to give a measurement of the inductance variations in the motor; as mentioned earlier an inductance measurement can be used to derive the rotational position of the motor rotor. Unfortunately this current ripple is small and the signal-to-noise ratio of this measurement is poor, which degrades the accuracy of this position-measurement method.

What is needed is an accurate sensing mechanism for motor position control which does not require external sensors or introduced stimulus signals, reduces cost and improves reliability. The present invention addresses these needs and provides for measurement verification using standard methods which are known.

### SUMMARY OF THE INVENTION

The main aspect of the present invention is to provide a motor position sensing mechanism for synchronous motors and brushless DC motors that does not require external sensors to be attached to the motor.

Another aspect of the present invention is to provide for a motor position-sensing mechanism that does not inject any extra signals or currents into the motor mechanism.

Another aspect of the present invention is to provide good speed and positional feedback to the controlling circuitry.

Another aspect of the present invention is to insure good position control for the motor mechanism, even when the motor is stopped, idle or actively maintaining its position via a controlling servo.

Another aspect of the present invention is to insure that the motor positional control functions under any condition from stalled to unloaded.

Other aspects of this invention will appear from the following description and appended claims, reference being made to the accompanying drawings forming a part of this specification wherein like reference characters designate corresponding parts in the several views.

The present invention measures motor winding inductance using the AC component of the pulse-width modulated motor drive current as a measurement stimulus, and derives the measurement by monitoring AC response at the center-node of a Y-connected winding. The present invention utilizes dynamic changes in that measured inductance to accurately track the position of the motor.

### BRIEF DESCRIPTION OF THE DRAWINGS

FIG. 1 is an illustration of prior art showing one type of electric motor. (previously described)

FIG. 1a depicts one section of the electric motor of FIG. 1 showing parts of the stator and rotor. (previously described)

FIG. 1b depicts the same section of the electric motor of after the rotor has moved 15 degrees. (previously described)

FIG. 2 depicts a linear motor. (previously described)

FIG. 3a depicts a simple analog motor-winding driver (previously described)

FIG. 3b shows a Pulse-Width Modulated (PWM) driver equivalent to the driver in FIG. 3a (previously described)

FIG. 4 shows the PWM stimulus and center-node response for a typical 3-phase motor.

FIG. 5 is a graph showing actual measured winding inductance variations for a typical motor.

FIG. 6 is a graph of the output sense voltage showing the effects of commutation on the amplitude of the center-node voltage response.

FIG. 7 is a schematic block diagram for one example embodiment of the present invention.

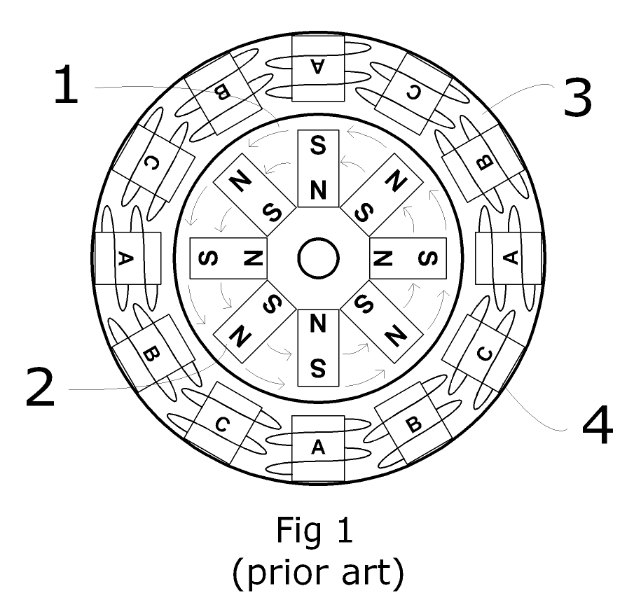

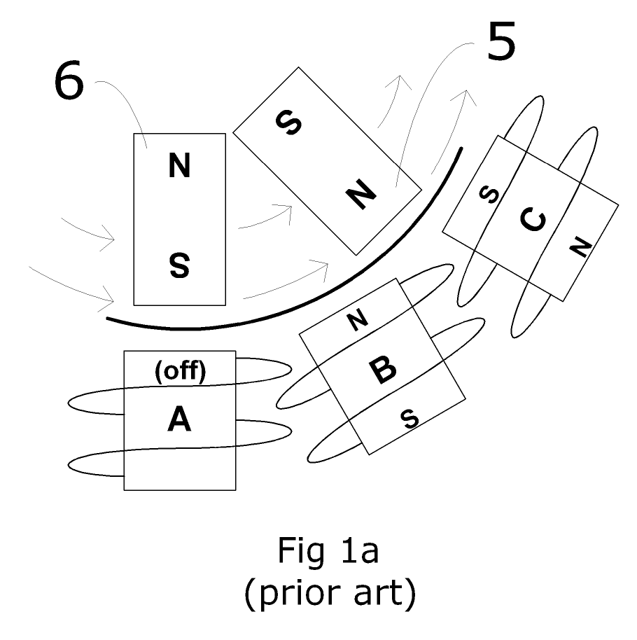

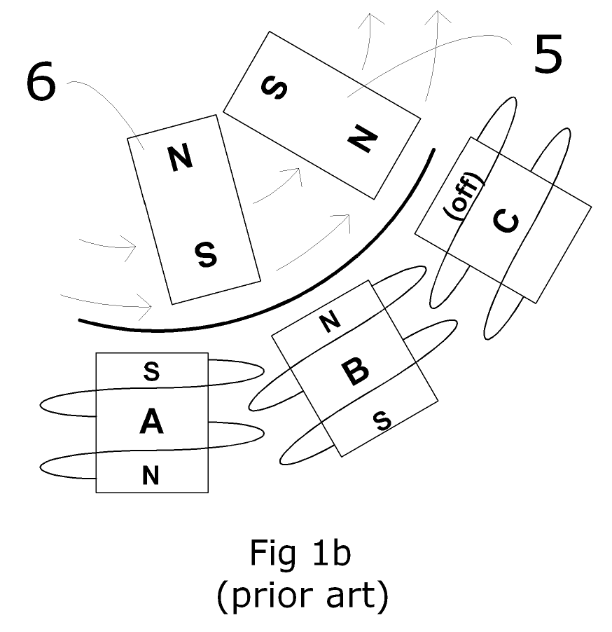

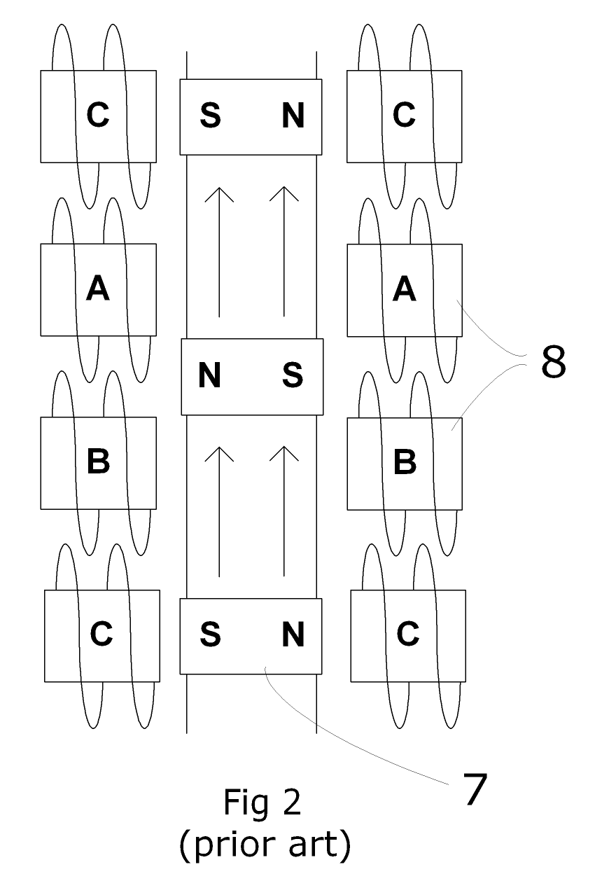

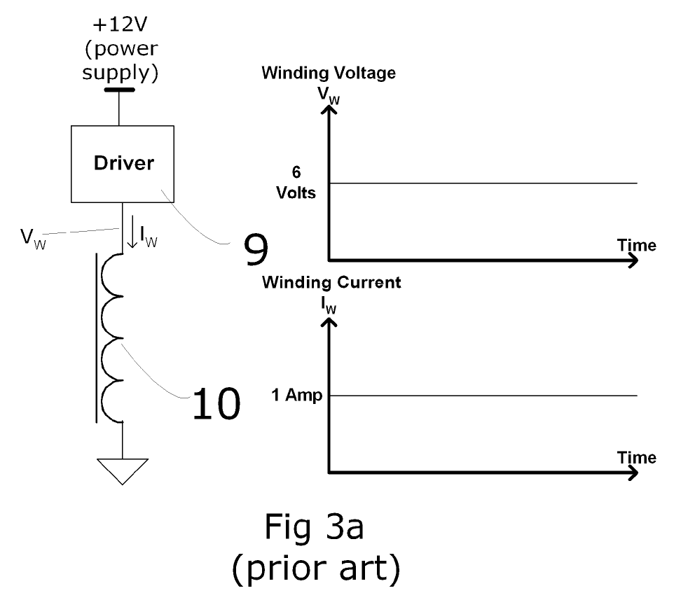

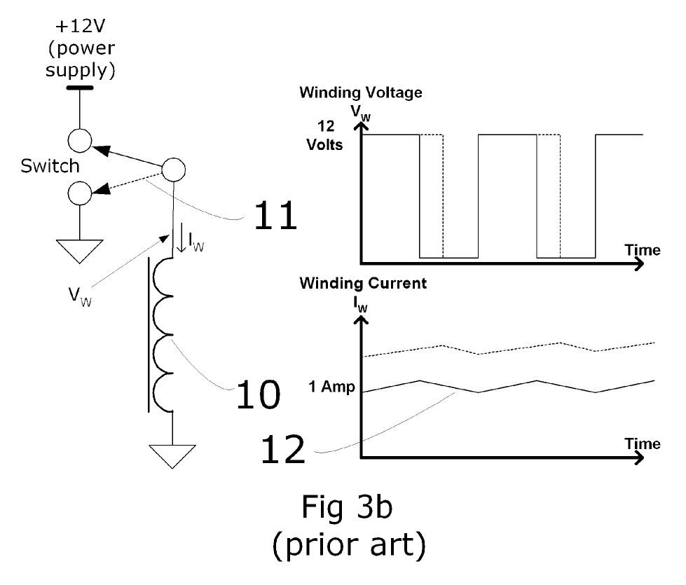

Before explaining the disclosed embodiment of the present invention in detail, it is to be understood that the invention is not limited in its application to the details of the particular arrangement shown, since the invention is capable of other embodiments. Also, the terminology used herein is for the purpose of description and not of limitation.

### DETAILED DESCRIPTION OF INVENTION AND DRAWINGS

The present invention provides a circuit and method for position sensing of polyphase motors without requiring external sensors to be attached to the motor and using only the common Pulse-Width Modulation for a measurement stimulus. The present invention does not inject extraneous signals or currents into the motor for position detection. Position sensing must be accurate enough to provide good control for motor commutation, and must provide good speed and position feedback for a servo controller. Furthermore, position sensing must work even when the motor is stopped in either an idle mode or actively maintaining its position via a position servo. Position sensing of the present invention must work under any motor-loading condition from stalled to unloaded and free-running.

The present invention employs the use of a novel method of performing a winding inductance measurement that avoids many of the aforementioned problems with earlier sensorless schemes.

The key feature of the present invention is that it takes advantage of the AC component of the Pulse-Width Modulation which is typically used to drive motor windings, and derives an inductance measurement from the AC voltage response at the center (neutral) node of a Y-connected motor.

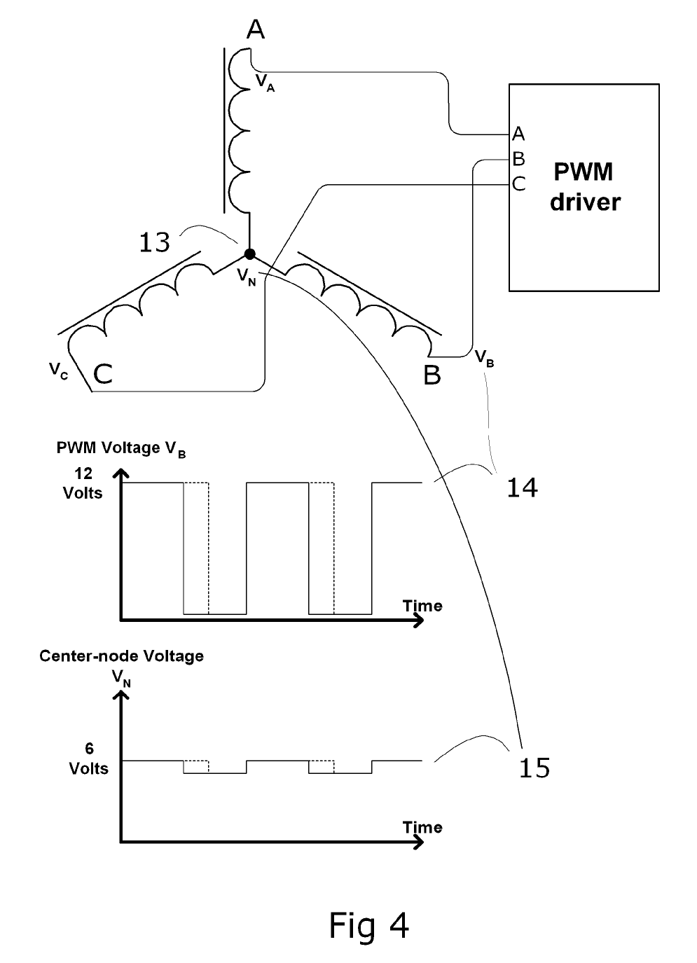

FIG. 4 shows the expected voltage response of a motor to the PWM stimulus 14 (graph shown for motor phase B only). Most motors in present use are Y-connected in the manner shown, which provides a center node 13 which is common to all windings. The amplitude of the square-wave response 15 at the center node 13 is determined by the ratio of inductance between the motor windings. The voltage amplitude of this response can be measured electronically by well-known methods. The amplitude grows higher and lower predictably according to motor rotor position.

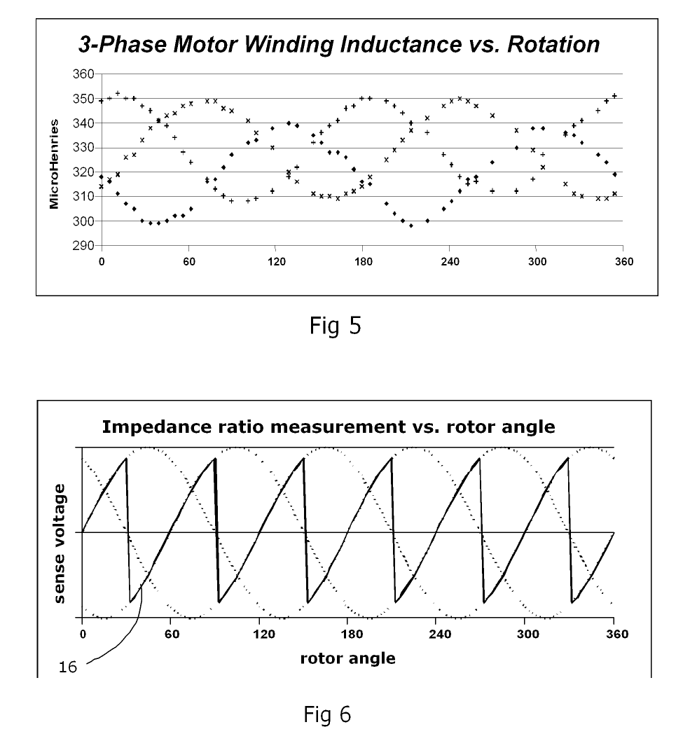

FIG. 5 is a graph showing measured inductance-ratio sense voltages as a typical motor rotates. During motor operation, the motor drivers are switched so that different winding pairs are driven; this is the process of commutation as previously described. As the windings are switched, the position-sense measurement is also switched from winding to winding. Therefore we will never see the complete waveforms as shown in FIG. 5 but only the parts that are used during normal motor operation. This waveform may be even more complex when using more sophisticated drive waveforms instead of simple commutation.

FIG. 6 is a graph of the output sense voltage showing the effects of commutation on the impedance-ratio sense voltage. Sense voltage signal line 16 represents the amplitude of the center-node signal. When the measured rotation reaches pre-selected points, commutation logic will switch to the next phase and the sense outputs will also switch accordingly. A particular voltage along the signal curve 16 represents a particular rotational position of the rotor, so appropriate signal processing of voltage 16 can determine the rotor position as precisely as needed. Monitoring the position changes over time also give measurements of rotational speed. These speed and position signals are available as outputs, to be used by external servo, control, and monitoring functions.

The sense output does not distinguish between the presence of a North pole or a South pole, so it repeats its waveform for both types of poles. This means that the waveform is repeated twice every full electrical cycle (every 180 electrical degrees of motion). This gives an ambiguity in the position output. This ambiguity can be resolved by initializing the sense circuitry using another position sensing technique. The initialization need be done only once after power-up, to resolve the ambiguity and thenceforth the inductance ratio sensing can track the position correctly. Possible techniques for initialization might include the use of any of the described prior art, or might include driving the motor blindly (without position feedback) to move it to a known position. Thus, the use of such conventional methods in conjunction with the winding inductance measurement of the present invention provides a means for verifying and resolving ambiguity in the motor positioning sensed by the present invention.

The inductance-ratio sensing of the present invention is based on current through the driven winding so it can only function when PWM current is flowing through the motor. When the motor is off, a small AC current must be fed through the motor to maintain position sensing and tracking. This can be accomplished with small currents that are too small to cause any motor motion but are still sufficient for the position sensing, or an AC voltage signal with no DC component can be generated by appropriate operation of the PWM switch apparatus.

### Example Embodiment of the Present Invnetion

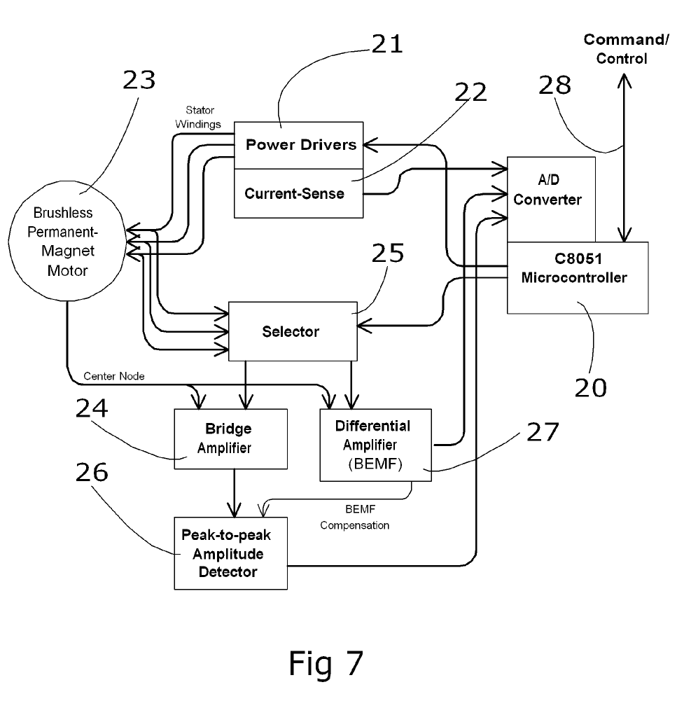

FIG. 7 is a schematic block diagram for one example embodiment of the present invention. The following description of an embodiment of the present invention is given only as an example implementation which has been shown to work. Many other embodiments (not shown) that are within the scope of the present invention are possible. The present invention is therefore not limited by the description of the following embodiment, but only by its claims.

The implementation as shown in FIG. 7 is based around a C8051 microcontroller 20 made by Silicon Laboratories. This microcontroller is a general purpose embedded controller which includes EEPROM and RAM memory, Pulse-Width Modulation (PWM) controllers, several parallel I/O bits, provision for communication with other processors, Analog-to-Digital (A/D) converter, and other internal peripherals. Many of these internal features proved useful in this design. The C8051 controls power drivers 21, which switch drive current appropriately into stator windings of the motor 23. Software in the microcontroller 20 determines which windings should be driven, as appropriate for commutation for the instantaneous rotor position. Microcontroller 20 contains PWM control circuitry to generate the PWM cycle described earlier. The winding driver also includes current-sense circuitry 22 which measures the winding currents to allow the microcontroller software to monitor and control the motor torque by commanding changes in the PWM pulse width.

To sense rotor-position, the motor center-node voltage is brought into bridge amplifier 24 which operates with selector switch 25 in the manner described in U.S. Pat. No. 6,703,805. The output of the bridge amplifier contains the AC voltage response of the motor center-node, the amplitude of which provides our rotor-position information. The peak-to-peak amplitude detector 26 extracts that amplitude and transmits it to the software in the microcontroller 20. The signal is converted to a digital value in the A/D converter, then software routines process it digitally using known motor inductance curves to calculate and track the rotor position. The calculations use lookup tables and simple arithmetic operations to derive the rotor position. Since different motors have different characteristic voltage response waveforms, the lookup tables are calibrated for the specific motor in use. The calculated motor position is fed back into the commutation software. In addition, timing of changes in motor position are be used to measure rotational speed. Both position and speed can be controlled or monitored depending on the system requirements for motor performance. It should be noted that FIG. 7 is a schematic block diagram and thus not all circuit connections are necessarily shown.

The motor center-node voltage is also fed to a differential amplifier 27 which measures the back-EMF voltage in the undriven winding of the motor. This voltage is fed to the peak detector 26 to compensate for effects of the back-EMF on the AC position measurement signal, but it is also fed to the microcontroller 20 via the A/D converter. The microcontroller software can use the back-EMF amplitude as a redundant rotor position measurement (but which is usable only at high motor rotational speeds).

Microcontroller 20 is interfaced to a master system processor or computer (not shown) though communication link 28. The master system processor can command specific motor RPM or position as needed by the system, and microcontroller 20 can report speed, position, current, etc. information to the master system processor. In this way, microcontroller 20 software is responsible only for running the motor and will not be required to handle any other system activity.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A DC electric motor with a drive current being rotated in sequence through electromagnets on a rotor or a stator thereby generating a rotating magnetic field, said drive current at any instant flowing through windings of a plurality of electromagnets operating in series, a rotor position detector comprising:
a Pulse-Width Modulated switch controlling the terminal voltages of the windings; said Pulse-Width Modulated terminal voltages controlling the current through the windings;
an AC component of said Pulse-Width Modulated terminal voltages being used as a measurement stimulus;
a means to measure a voltage response to said AC stimulus at a node between the driven electromagnets;
wherein the amplitude of said voltage response is consistently related to an inductance ratio between the driven electromagnets; said inductance ratio depending on a relative rotational position between the rotor and the stator;
and wherein said signal amplitude thereby defines the rotor position relative to the stator.

2. The apparatus of claim 1 further comprising one or more position sensors attached to the motor, said sensors measuring a starting or a low-resolution position, thereby providing means functioning to verify and resolve ambiguity in a rotor position sensed by said improved rotor position detector.

3. The apparatus of claim 1 further comprising an electronic signal processor using as its input said voltage response at the node between the driven electromagnets, and generating as its output a measurement of the relative position between rotor and stator.

4. The apparatus of claim 3 generating absolute position information, where the absolute position information is used to control switches for motor commutation, appropriately synchronizing the rotating magnetic field with rotor position.

5. The apparatus of claim 3 generating position information, where the position information is used to control current waveform generation for sinusoidal or other arbitrary motor-drive waveforms, where the waveform advances according to motor position and speed, appropriately synchronizing the rotating magnetic field with rotor position.

6. The apparatus of claim 3 generating velocity information, where the velocity information is used as feedback to a servo controller.

7. The apparatus of claim 3 generating position information, where the position information is used as feedback to a servo controller.
